(19) United States
(12) Patent Application Publication
(10) Pub. No.: US 2008/0074605 A1
(43) Pub. Date: Mar. 27, 2008

(54) LIQUID CRYSTAL COMPOSITION AND LIQUID CRYSTAL DISPLAY COMPRISING THE SAME

(75) Inventors: Il-Kook Huh, Yongin-si (KR); Jeong-Uk Heo, Seongnam-si (KR); Nam-Seok Lee, Suwon-si (KR)

Correspondence Address: MACPHERSON KWOK CHEN & HEID LLP, 2033 GATEWAY PLACE, SUITE 400, SAN JOSE, CA, 95110, US

(73) Assignee: SAMSUNG ELECTRONICS CO., LTD, Suwon-Si (KR)

(21) Appl. No.: 11/862,361

(22) Filed: Sep. 27, 2007

(30) Foreign Application Priority Data
Sep. 27, 2006 (KR) 10-2006-0093996

(51) Int. Cl. C09K 19/12; C09K 19/06

(52) U.S. Cl. 349/182; 252/299.6; 252/299.63; 252/299.66; 428/1.1

(57) ABSTRACT

A liquid crystal composition and a display having the same are provided. The liquid crystal composition includes a first class including a neutral liquid crystal compound, and a second class including a polar liquid crystal compound having at least one fluorine atom. The second class includes a liquid crystal compound represented by Chemical Formula (I):

R₁—CF₂O—R₂ (I)

where R₁ and R₂ may be the same or different, and has an aromatic ring having at least one fluorine atom. The liquid crystal compound represented by Chemical Formula (I) is included at less than about 22 wt % of the total content of the liquid crystal composition in one example.

### CROSS-REFERENCE TO RELATED APPLICATION

This application claims priority to and the benefit of Korean Patent Application No. 10-2006-0093996 filed in the Korean Intellectual Property Office on Sep. 27, 2006, the entire contents of which are incorporated herein by reference.

### BACKGROUND OF THE INVENTION

(a) Field of the Invention

The present invention relates to a liquid crystal composition and a liquid crystal display comprising the same.

(b) Description of the Related Art

A liquid crystal display (LCD) is one of the most widely used flat panel displays. A liquid crystal display includes two display panels in which field generating electrodes are formed, and a liquid crystal layer interposed between the two display panels. A voltage is applied to the field generating electrodes to generate an electric field in the liquid crystal layer so as to determine the orientation of liquid crystal molecules in the liquid crystal layer and to adjust the transmittance of light that passes through the liquid crystal layer.

In the liquid crystal display, a liquid crystal is very important to adjust the transmittance of light and attain a desired image.

Meanwhile, a liquid crystal used in a liquid crystal display is thermotropic, such that its phase is changed by temperature.

A liquid crystal exists in a smectic phase or a nematic phase in a specific temperature range (hereinafter, referred to as an “operating temperature range”), and it can adjust the transmittance of light. If the temperature is below the operating temperature range, the liquid crystal will be in a crystal state. If the temperature is over the operating temperature range, the liquid crystal will be in an isotropic liquid state so as to not function as a crystal. Therefore, it is advantageous for a liquid crystal to have a wide operating temperature range.

Accordingly, the technical subject of the present invention is to provide a liquid crystal composition having a wide operating temperature range.

### SUMMARY OF THE INVENTION

The present invention provides a liquid crystal composition and a liquid crystal display having the same having advantages of a wide operational temperature range. According to an embodiment of the present invention, there is provided a liquid crystal composition including a first class including a neutral liquid crystal compound, and a second class including a polar liquid crystal compound having at least one fluorine atom. The second class includes a liquid crystal compound represented by the Chemical Formula (I):

R₁—CF₂O—R₂ (I)

, wherein each of R₁ and R₂ independently may include an aromatic ring having at least one fluorine atom. The liquid crystal compound represented by Chemical Formula (I) is included at less than about 22 wt % of total content of the liquid crystal composition in one example.

The liquid crystal compound represented by Chemical Formula (I) may be represented by Chemical Formula (II):

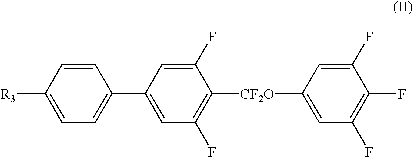

, where R₃ is one of an alkyl group, alkoxy group, and alkenyl group having 1 to 10 C atoms.

The first class may include at least one of the liquid crystal compounds represented by the Chemical Formulas (III), (IV), and (V):

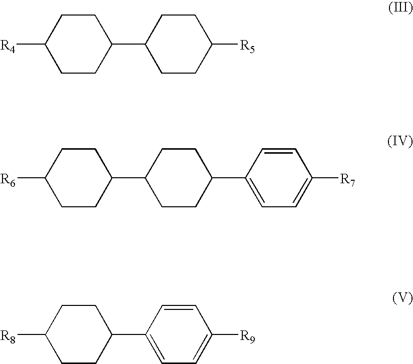

, wherein each of R₄ to R₉ may be independently of one another an alkyl group, an alkoxy group, or an alkenyl group having 1 to 10 C atoms.

The second class may include a first sub-class including a liquid crystal compound having a —CF₂O— group and a second sub-class including a liquid crystal compound not having a —CF₂O— group. The first sub-class may include a liquid crystal compound represented by Chemical Formula (II) and a liquid crystal compound represented by Chemical Formula (VI):

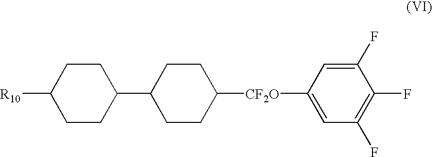

, wherein R₁₀ is one of an alkyl group, an alkoxy group, and an alkenyl group having 1 to 10 C atoms. The second sub-class includes at least one of the liquid crystal compounds represented by Chemical Formulas (VII), (VIII), (IX), and (X):

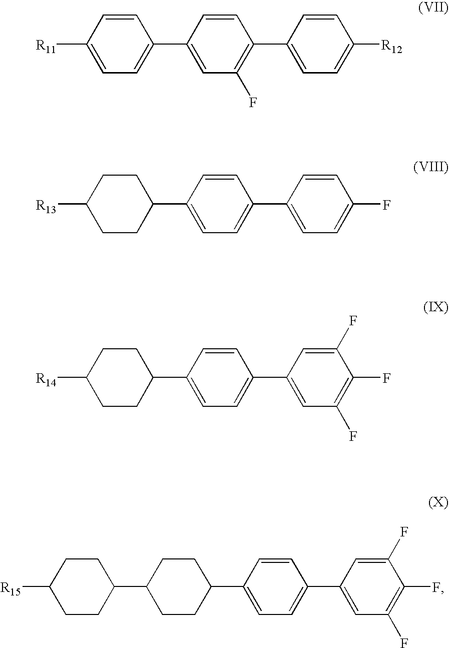

wherein each of R₁₁ to R₁₅ may be independently of one another an alkyl group, an alkoxy group, or an alkenyl group having 1 to 10 C atoms.

The first class may be included at about 40 to 55 wt % of the total content of the liquid crystal composition. The first sub-class may be included at about 30 to 40 wt % of the total content of the liquid crystal composition. The second sub-class may be included at about 10 to 30 wt % of the total content of the liquid crystal composition.

The liquid crystal composition may have an operational temperature range of about −40° C. to about 80° C. in one example.

The liquid crystal composition may have dielectric anisotropy (Δ∈) of about 8 to 15, and refractive anisotropy (Δn) of about 0.09 to 0.115 in one example.

According to another embodiment of the present invention, there is provided a liquid crystal display including a first substrate, a second substrate, a pair of field generating electrodes, and a liquid crystal layer. The second substrate faces the first substrate. The pair of field generating electrodes is formed on at least one of the first substrate and the second substrate, and the liquid crystal layer is interposed between the first substrate and the second substrate. The liquid crystal layer comprises a liquid crystal composition including: a first class including a neutral liquid crystal compound, and a second class including a polar liquid crystal compound having at least one fluorine atom. The second class includes a liquid crystal compound represented by the Chemical Formula (I), and the liquid crystal compound represented by Chemical Formula (I) is included at less than about 22 wt % of total content of the liquid crystal composition in one example.

The liquid crystal display may further include a first signal line and a second signal line, and a thin film transistor. The first signal line and the second signal line are formed on the first substrate to cross each other. The thin film transistor is connected to the first signal line, the second signal line, and the field generating electrodes.

### BRIEF DESCRIPTION OF THE DRAWINGS

FIG. 1 is a layout view of a liquid crystal display according to an embodiment of the present invention.

FIG. 2 and FIG. 3 are cross-sectional views of a liquid crystal display of FIG. 1 taken along the lines II-II and III-III, respectively.

FIG. 4A and FIG. 4B are graphs showing phase transition enthalpy of panel 2 and panel 4 with respect to temperature, respectively.

FIG. 4C is a graph showing variation of phase transition enthalpy with respect to temperature of a panel 5.

### DETAILED DESCRIPTION OF THE EMBODIMENTS

A liquid crystal composition according to an embodiment of the present invention will now be explained. The liquid crystal composition includes many kinds of liquid crystal compounds that differ from each other in physical characteristics. A liquid crystal compound may include a core group making a central axis and a terminal group and/or a lateral group connected to the core group. The core group may include at least one of cyclic groups selected from a phenyl group, a cyclohexyl group, and heterocycles. The terminal group and/or lateral group may include a non-polar group such as an alkyl group, an alkoxy group, and an alkenyl group, and a polar group including a fluorine atom (F). The physical characteristics such as dielectric anisotropy vary with the terminal group and/or lateral group.

The liquid crystal composition according to an embodiment of the present invention includes a neutral compound not having dielectric anisotropy and a polar compound having dielectric anisotropy.

The neutral compound is a liquid crystal compound not having a fluorine atom in the core group, terminal group, and lateral group, and, for example, may include one or more compounds selected from a group represented by the following Chemical Formulas (III) to (V).

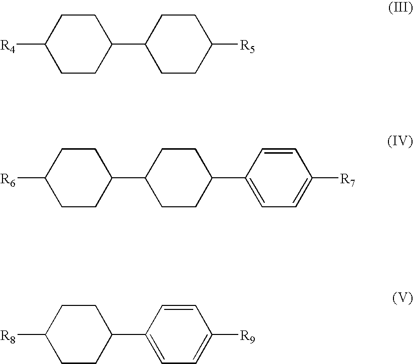

Herein, each of R₄ to R₉ may be the same or different, and may contain one selected from an alkyl group, an alkoxy group, or an alkenyl group having C₁ to C₁₀, independently.

The neutral compound may be contained at about 40 to about 55 wt % of the total content of the liquid crystal composition in one example.

The polar compound is a liquid crystal compound having at least one fluorine atom in the core group, the terminal group, or the lateral group. The polar compound may be classified as a middle polar compound and a high polar compound according to the presence of a —CF₂O— group connected to the core group.

The middle polar compound has no —CF₂O— group in the core group but has a phenyl group and/or a cyclohexyl group connected to the core group. For example, the middle polar compound may include one or more compounds selected from compounds represented by the following Chemical Formulas (VII) to (X).

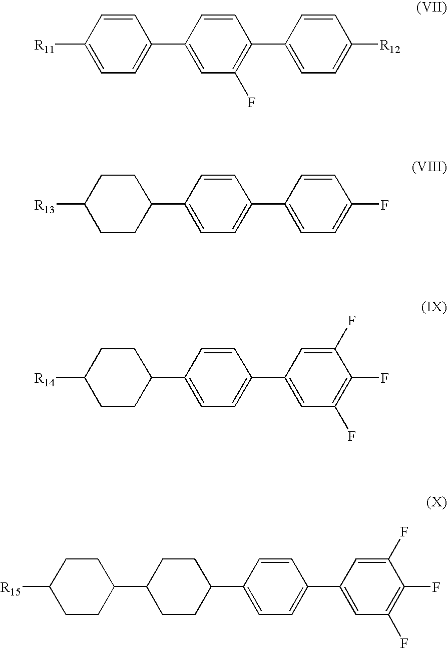

Herein, each R₁₁ to R₁₅ may be the same or different, and may contain one selected from an alkyl group, an alkoxy group, or an alkenyl group having C₁ to C₁₀, independently.

The middle polar compound may preferably be included at about 10 to about 30 wt % of the total content of the liquid crystal composition in one example.

The high polar compound has a —CF₂O— group connected to the core group, and therefore the liquid crystal composition has strong dielectric anisotropy.

The high polar compound includes a liquid crystal compound represented by the following Chemical Formula (I).

R₁—CF₂O—R₂ (I)

Herein, R₁ and R₂ may be the same or different, and each may be an aromatic ring having at least one fluorine atom.

The liquid crystal compound represented by Chemical Formula (I) may be represented as the same structure in which a —CF₂O— group is connected to two phenyl groups as in the following Chemical Formula (II).

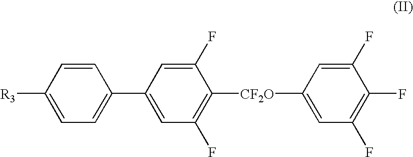

Herein, R₃ may be an alkyl group, an alkoxy group, or an alkenyl group having C₁ to C₁₀.

Also, the high polar compound may further include a liquid crystal compound represented by Chemical Formula (VI).

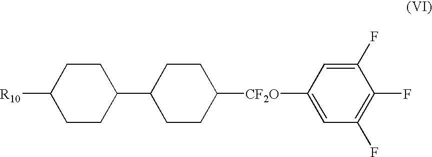

Herein, R₁₀ may be an alkyl group, an alkoxy group, or an alkenyl group having C₁ to C₁₀.

The liquid crystal compound represented by Chemical Formula (VI) is a structure in which at least one end of a —CF₂O— group is connected to a cyclohexyl group, and is different from the liquid crystal compound represented by Chemical Formula (II).

The high polar compound is preferably contained at about 30 to about 40 wt % of the total content of the liquid crystal composition in one example.

In the present invention, the content of the liquid crystal compound represented by Chemical Formula (I) among the high polar compounds is limited. The inventor discovered that the liquid crystal compound represented by Chemical Formula (I) has high dielectric anisotropy, but it is difficult to rotate due to the steric hindrance of a —CF₂O— group, and therefore it is easy to crystallize because of the structure of molecules. Therefore, the present invention limits the content of the liquid crystal compound represented by Chemical Formula (I) to lower the crystallization phase transition temperature, widening the operating temperature range.

The following experiment has been carried out.

Two display panels in which electrodes were formed were assembled, and different kinds of liquid crystal compositions were injected between the two display panels, making six liquid crystal panels for testing.

Each liquid crystal composition included a liquid crystal compound represented by Chemical Formulas (II), (III), (IV), (V), (VI), (VII), (IX), and (X). The liquid crystal panels for testing had about 15 wt % (panel 1), about 18 wt % (panel 2), about 19 wt % (panel 3), about 22 wt % (panel 4), about 25 wt % (panel 5), and about 30 wt % (panel 6) of the liquid crystal composition represented by Chemical Formula (II), and the other components were equal.

First, the phase transition of the liquid crystal compositions in response to temperature was tested.

The liquid crystal panels made as described above were cooled to about −50° C. at a speed of about −5° C./min and held at about −50° C. for about 60 minutes, intentionally crystallizing the liquid crystal composition. Also, while increasing the temperature to about 90° C. at a speed of about 5° C./min, the enthalpy changes (ΔH) and phase transition of the liquid crystal composition were measured using differential scanning calorimetry (DSC).

The results are shown in Table 1.

TABLE 1

| | Smectic -> Nematic transition | Crystal->Liquid |
|---|---|---|
| | temperature | transition temperature |
| Panel No. | (weak endothermic, ° C.) | (strong endothermic, ° C.) |
| 1 | −32~−29 | — |
| 2 | −46~−18 | — |
| 3 | −48~−20 | — |
| 4 | −48~−25 | — |
| 5 | | −7~13 |
| | | 17~36 |
| 6 | | −5~20 |
| | | 20~−36 |

As shown in Table 1, in panel 1, panel 2, panel 3, and panel 4, a weak endothermic reaction was detected at about −32 to about −29° C., about −46 to about −18° C., about −48 to about −20° C., and about −48 to about −25° C., respectively. The weak endothermic reaction means that the phase transition from a smectic phase to a nematic phase occurs.

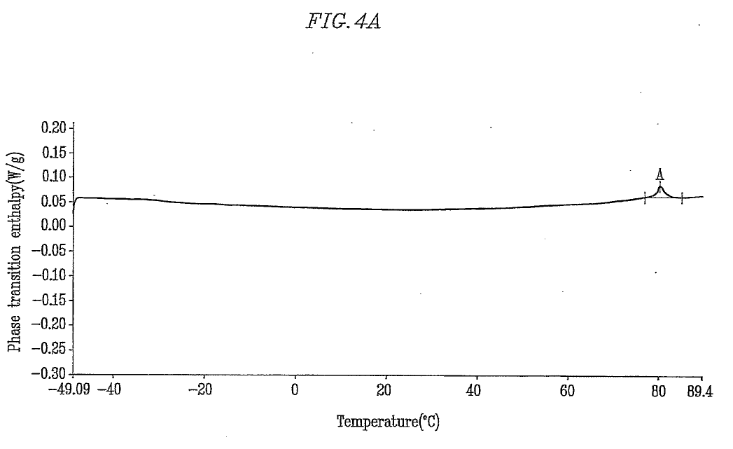

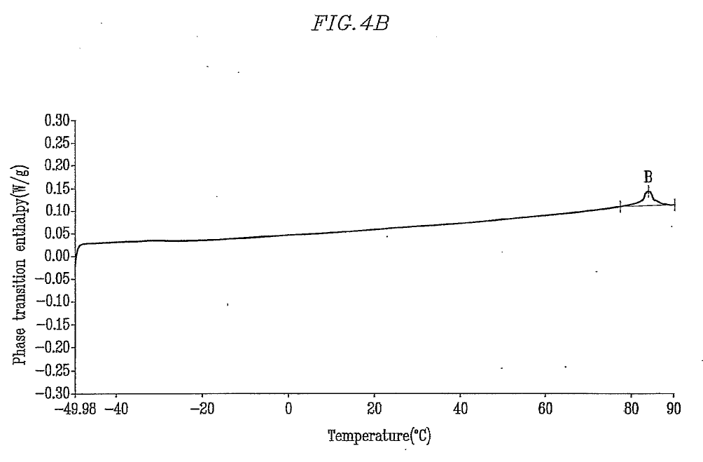

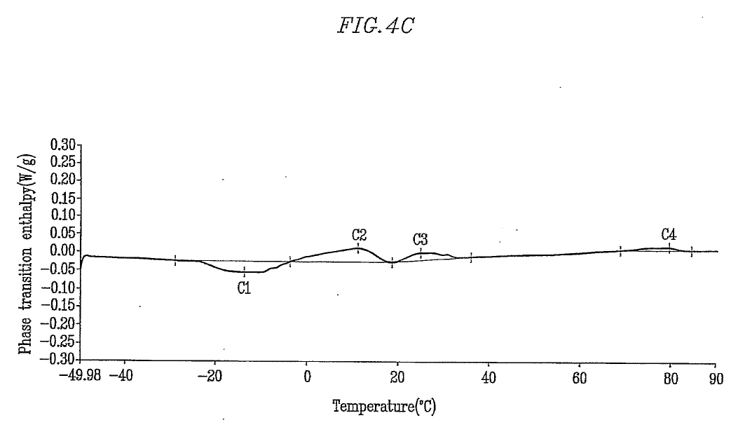

Also, as shown in FIGS. 4A and 4B, in panel 1, panel 2, panel 3, and panel 4, a strong endothermic reaction was detected at more than about 80° C., thereby showing the approximate temperature at which the phase transition from a nematic phase to an isotropic liquid phase occurs.

This will be described with reference to FIG. 4A and FIG. 4B.

FIG. 4A and FIG. 4B are graphs showing phase transition enthalpy of panel 2 and panel 4 according to temperature, respectively.

In FIG. 4A, “A” is a strong endothermic peak in which the phase transition from a nematic phase to an isotropic liquid phase occurs, wherein ΔH=1.038 J/g and the phase transition temperature is about 80.01° C. In FIG. 4B, “B” is a strong endothermic peak in which the phase transition from a nematic phase to an isotropic liquid phase occurs, wherein ΔH=1.356 J/g and the phase transition temperature is about 83.85° C. No weak endothermic portions are indicated in FIG. 4A and FIG. 4B.

As described above, in panel 1, panel 2, panel 3, and panel 4, it is noted that the phase transition occurs in the order of a crystal, a smectic phase, a nematic phase, and an isotropic liquid phase in the liquid crystal composition. Herein, it is noted that since the smectic phase and the nematic phase are a liquid crystal state, the crystal phase transition temperature at which the liquid crystal will become a crystal is at most less than about −40° C., and the liquid phase transition temperature at which the liquid crystal will become an isotropic liquid is more than about 80° C. Therefore, it is noted that the operating temperature range of the liquid crystal is about −40° C. to about 80° C.

Meanwhile, in panels 5 and 6, the result was different from panels 1 to 4. This will be described with reference to FIG. 4C. FIG. 4C is a graph showing variation of phase transition enthalpy according to temperature of panel 5.

As shown FIG. 4C, in panel 5, an exothermic reaction was detected at about −32 to about −7° C., and a strong endothermic reaction was detected at about −7 to about 13° C. and about 17 to about 36° C. Also, in panel 6, an exothermic reaction was detected at about −24.5 to about −5° C., and a strong endothermic reaction was detected at about −5 to about 20° C. and about 20 to about 36° C. (not shown).

Herein, “C1” denotes an exothermic peak point with ΔH=−4.460 J/g. At this moment, the temperature is about −14.07° C. “C2” denotes a strong endothermic peak point with ΔH=5.755 J/g. The temperature thereof is about 10.68° C. “C3” denotes a strong endothermic peak point with ΔH=2.173 J/g. The temperature thereof is about 24.60° C. “C4” is a weak endothermic peak point with ΔH=0.822 J/g. The temperature thereof is about 79.43° C.

The term “exothermic reaction” means that the liquid crystal compound does not transit or change its phase and still remains in a crystal state, and the term “strong endothermic reaction” means that a crystal transitions directly to a nematic phase with no smectic phase. In this case, as the liquid crystal is cooled, a nematic phase transitions directly to a crystal phase, making the crystal phase transition temperature higher and the operating temperature range of the liquid crystal composition narrower.

As described above, it is noted that the crystal phase transition temperature is determined by the content of the liquid crystal compound represented by Chemical Formula (I) such as compound represented by Chemical Formula (II), and that if the liquid crystal compound represented by Chemical Formula (I) is less than about 22 wt % of the total content of the liquid crystal composition, it has a wide phase transition temperature of about −40° C. to about 80° C.

Next, the time when the liquid crystal composition was crystallized at a certain temperature was tested.

After leaving panel 1 to panel 6 at about −25° C., time when the liquid crystal composition was crystallized was measured.

The results are shown in Table 2.

TABLE 2

| | Panel No. | | | | | |
|---|---|---|---|---|---|---|
| | 1 | 2 | 3 | 4 | 5 | 6 |
| Crystallization | >500 | >500 | 250 | 220 | 96 | 96 |
| time | | | | | | |
| (−25° C., hours) | | | | | | |

As shown in Table 2, in panels 1 and 2, no crystallization of the liquid crystal composition was detected for over 500 hours, but the liquid crystal composition was crystallized in about 250 hours in panel 3 and about 220 hours in panel 4. Meanwhile, in panel 5 and panel 6, the liquid crystal composition was crystallized in about 96 hours.

As described above, it is noted that the time to crystallize varies with the content of the liquid crystal compound represented by Chemical Formula (I), and the case in which the content of the liquid crystal compound represented by Chemical Formula (I) is about 22 wt % is appropriate in view of the reference that the crystallization does not occur for about 200 hours at about −25° C.

It is noted that the operating temperature range of the liquid crystal composition is determined in response to the content of the liquid crystal compound represented by Chemical Formula (I).

In addition, the liquid crystal composition according to the present invention has a wide operating temperature range, and it simultaneously has dielectric anisotropy (ΔH) of 8 to 15, refractive anisotropy (Δn) of 0.09 to 0.115, and rotation viscosity of 50 to 250 mPa·s, which are all satisfactory.

A liquid crystal display according to an embodiment of the present invention will hereinafter be described in detail with reference to the accompanying drawings in order that those skilled in the art can easily practice the invention. As those skilled in the art would realize, the described embodiments may be modified in various different ways, all without departing from the spirit or scope of the present invention.

In the drawings, the thickness of layers, films, panels, regions, etc., may beexaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

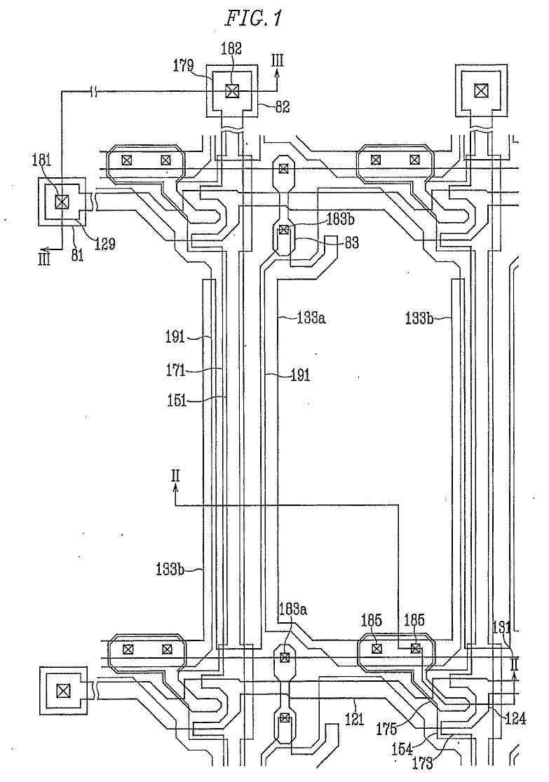

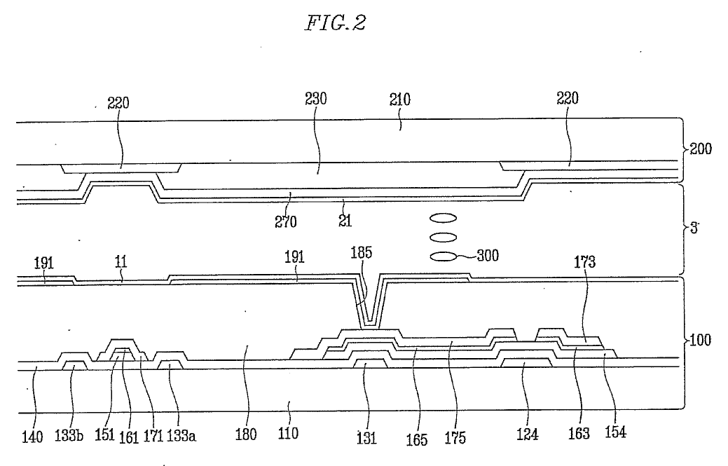

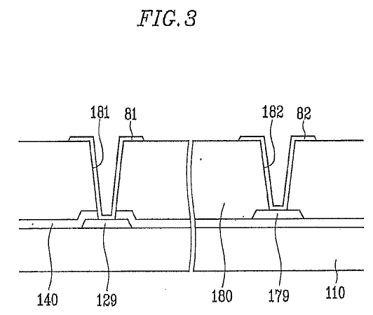

A liquid crystal display (LCD) according to an embodiment of the present invention will now be described in detail with reference to FIG. 1 to FIG. 3. FIG. 1 is a layout view of the LCD according to an embodiment of the present invention, and FIG. 2 and FIG. 3 are cross-sectional views of the LCD taken along the lines II-II and III-III of FIG. 1, respectively.

Referring to FIG. 1 to FIG. 3, the LCD according to an embodiment of the present invention includes a thin film transistor array panel 100 and a common electrode panel 200 that face each other, and a liquid crystal layer 3 interposed therebetween.

The thin film transistor array panel 100 will now be described.

A plurality of gate lines 121 (only one shown) and a plurality of storage electrode lines 131 (only one shown) are formed on an insulating substrate 110 made of transparent glass or plastic in one example.

The gate lines 121 transmit gate signals and extend basically in a horizontal direction. Each gate line 121 includes a plurality of gate electrodes 124 (only one shown) that protrude downward and a wide end portion 129 for connecting with another layer or external driving circuits. A gate driving circuit (not shown) for generating the gate signals may be mounted on a flexible printed circuit film (not shown) attached on the substrate 110 or mounted directly on the substrate 110, or may be integrated with the substrate 110.

The storage electrode lines 131 receive a predetermined voltage, and have stem lines extending almost parallel to the gate lines 121 and a plurality of pairs of first and second storage electrodes 133a and 133b (only one pair shown) that branch off from the stem lines. Each storage electrode line 131 is disposed between two adjacent gate lines 121, and its stem line is placed closer to the upper one of the two adjacent gate lines 121. The storage electrodes 133a and 133b include a fixed end connected to the stem line and a free end opposite to the fixed end. The fixed end of the first storage electrode 133a has a wide area, and the free end has two parts, that is, a straight part and a bent part. The shape and disposition of the storage electrode line 131 may be changed variously.

The gate lines 121 and the storage electrode lines 131 may be made of an aluminum-(Al)-containing metal including Al and an Al alloy, a silver—(Ag)-containing metal including Ag and a Ag alloy, a copper—(Cu)-containing metal including Cu and a Cu alloy, a molybdenum—(Mo)-containing metal including Mo and a Mo alloy, or a low resistive conductor such as chromium (Cr), tantalum (Ta), and titanium (Ti). However, they may have a multi-layered structure including two conductive layers (not shown) that have different physical properties from each other.

The sides of the gate line 121 and storage electrode line 131 are inclined to the surface of the substrate 110, and the inclination angles are preferably in a range of about 30 to about 80 degrees.

A gate insulating layer 140 made of silicon nitride (SiNx) or silicon oxide (SiO₂), in one example, is formed on the gate lines 121 and the storage electrode lines 131.

A plurality of semiconductor stripes 151 (only one shown) made of hydrogenated amorphous silicon (a-Si) or polysilicon, in one example, are formed on the gate insulating layer 140. The semiconductor stripes 151 extend mainly in a vertical direction and have a plurality of projections 154 (only one shown) that protrude toward the gate electrodes 124.

A plurality of ohmic contact stripes and islands 161 and 165 (only one shown, respectively) are formed on the semiconductors stripes 151. The ohmic contacts 161 and 165 may be made of silicide or n+ hydrogenated a-Si in which an n-type impurity such as phosphorus (P) is highly doped. Each ohmic contact stripe 161 has a plurality of projections 163 (only one shown), and a projection 163 and an ohmic contact island 165 form a pair to be disposed on a projection 154 of a semiconductor stripe 151.

The sides of the semiconductor stripes 151 and the ohmic contacts 161 and 165 are also inclined to the surface of the substrate 110, and the inclination angles are in a range of approximately 30 to 80 degrees.

A plurality of data lines 171 (only one shown) and a plurality of drain electrodes 175 (only one shown) are formed on the ohmic contacts 161 and 165 and the gate insulating layer 140.

The data lines 171 transmit data signals and extend mainly in a vertical direction to intersect the gate lines 121. Each data line 171 also intersects the storage electrode lines 131 to run between adjacent storage electrodes 133a and 133b. Each data line 171 has a plurality of source electrodes 173 (only one shown) extending toward the gate electrodes 124 and a wide end portion 179 for connecting with another layer or external driving circuits. A data driving circuit (not shown) for generating the data signals may be mounted on the flexible printed circuit film (not shown) attached on the substrate 110 or directly mounted on the substrate 110, or may be integrated with the substrate 110.

The drain electrodes 175 are separated from the data lines 171 and face the source electrodes 173 with the gate electrodes 124 interposed therebetween.

One gate electrode 124, one source electrode 173, and one drain electrode 175 form a thin film transistor (TFT) together with the projection 154 of the semiconductor stripe 151, and the channel of the TFT is formed in the projection 154 between the source electrode 173 and the drain electrode 175.

The data lines 171 and the drain electrodes 175, like the gate lines 121 and the storage electrode lines 131, may be made of a low resistance conductor.

The sides of the data lines 171 and the drain electrodes 175 are also inclined to the surface of the substrate 110 at an inclination angle of about 30 to 80 degrees.

A passivation layer 180 is formed on the data lines 171, the drain electrodes 175, and exposed portions of the projections 154 of semiconductor stripes 151. The passivation layer 180 may be made of an inorganic insulator or an organic insulator, and its surface may be flat, in one example.

A plurality of contact holes 182 and 185 are formed in the passivation layer 180 to expose end portions 179 of the data lines 171 and the drain electrodes 175, respectively. A plurality of contact holes 181 (only one shown) to expose the end portions 129 of the gate lines 121, a plurality of contact holes 183a (only one shown) to expose a part of the storage electrode lines 131 around the fixed end of the first storage electrodes 133a, and a plurality of contact holes 183b (only one shown) to expose the projections of the free ends of the first storage electrodes 133a are formed in the passivation layer 180 and the gate insulating layer 140.

A plurality of pixel electrodes 191, a plurality of overpasses 83, and a plurality of contact assistants 81 and 82 (only one shown, respectively) are formed on the passivation layer 180. They may be made of a transparent conductive material such as indium tin oxide (ITO) or indium zinc oxide (IZO), or a reflective metal such as Al, Ag, Cr, or alloys thereof.

The pixel electrodes 191 are physically and electrically connected to the drain electrodes 175 through the contact holes 185, and receive a data voltage from the drain electrodes 175. Each pixel electrode 191 to which a data voltage is applied generates an electric field together with the common electrode 270 of the common electrode panel 200 to which a common voltage is applied so as to determine the orientation of liquid crystal molecules 300 in the liquid crystal layer 3 between the pixel electrode 191 and the common electrode 270. The polarization of light that passes through the liquid crystal layer varies depending on the determined orientation of the liquid crystal molecules. The pixel electrode 191 and the common electrode 270 form a capacitor (hereinafter referred to as a liquid crystal capacitor) to sustain the applied voltage even after the TFT is turned off.

The pixel electrode 191 is overlapped with the storage electrodes 133a and 133b and the storage electrode line 131. A capacitor formed by overlapping the pixel electrode 191 and the drain electrode 175 that is electrically connected to the pixel electrode 191 with the storage electrode line 131 is called a storage capacitor, and the storage capacitor enhances the voltage sustaining ability of the liquid crystal capacitor.

The contact assistants 81 and 82 are connected to the end portions 129 of the gate lines 121 and the end portions 179 of the data lines 171 through the contact holes 181 and 182, respectively. The contact assistants 81 and 82 supplement the connectivity of the end portions 129 of the gate line 121 and the end portions 179 of the data lines 171 with external devices, and protect them.

The overpasses 83 cross over the gate lines 121 and are connected to the exposed portions of the storage electrode lines 131 and the exposed free ends of the storage electrodes 133b through the contact holes 183a and 183b disposed on the opposite side with the gate lines 121 placed therebetween. The storage electrodes 133a and 133b and the storage electrode lines 131 may be used together with the overpasses 83 to correct defects of the gate lines 121, the data lines 171, or the TFTs.

The common electrode panel 200 facing the thin film transistor array panel 100 will now be described.

A light blocking member 220, which is also called a black matrix, is formed on the insulating substrate 210 that is made of transparent glass or plastic. The light blocking member 220 faces the pixel electrodes 191 and has a plurality of openings having almost the same shape as the pixel electrodes 191, preventing light leakage from between the pixel electrodes 191. The light blocking member 220 may comprise one portion corresponding to the gate lines 121 and the data lines 171 and another portion corresponding to the TFTs.

A plurality of color filters 230 (only one shown) are formed on the substrate 210. The color filters 230 are mainly placed in regions surrounded by the light blocking member 220 and may extend along the columns of the pixel electrodes 191 in a vertical direction. Each color filter 230 may display one of primary colors such as three primary colors of red, green, and blue.

A common electrode 270 made of a transparent conductor such as ITO or IZO is formed on the color filters 230.

Alignment layers 11 and 21 are coated on inner surfaces of the display panels 100 and 200, and they may be horizontal alignment layers.

Polarizers (not shown) are provided on outer surfaces of the display panels 100 and 200, and their polarization axes are parallel or perpendicular to each other. In the case of a reflective liquid crystal display, one of the two polarizers may be omitted.

The liquid crystal layer 3 comprises liquid crystal molecules 300 having positive dielectric anisotropy, and the major axis of the liquid crystal molecules 300 in the liquid crystal layer 3 are aligned to be almost horizontal to the surface of the display panels 100 and 200 when no electric field is generated.

The liquid crystal layer 3 includes a liquid crystal composition according the above embodiments.

In the above-mentioned embodiment of the present invention, a twisted nematic (TN) mode LCD is described. However, it will be easily understood by those skilled in the art that the present invention can be applied to a vertically aligned (VA) mode LCD or in-plane switching (IPS) mode LCD.

As described above, a liquid crystal composition according to an embodiment of the present invention can advantageously have a wide operating temperature range by adjusting the content of the specific liquid crystal components.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal composition, comprising:
a first class comprising a neutral liquid crystal compound; and
a second class comprising a polar liquid crystal compound having at least one fluorine atom and represented by Chemical Formula (I):
R₁—CF₂O—R₂ (I)
wherein each of R₁ and R₂ independently contains an aromatic ring having at least one fluorine atom, and
further wherein the liquid crystal compound represented by Chemical Formula (I) is less than about 22 wt % of total content of the liquid crystal composition.

2. The liquid crystal composition of claim 1, wherein:
the liquid crystal compound represented by Chemical Formula (I) is represented by Chemical Formula (II): 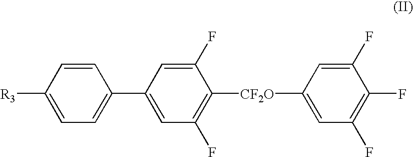
where R₃ is one of an alkyl group, an alkoxy group, and an alkenyl group having 1 to 10 C atoms.

3. The liquid crystal composition of claim 2, wherein:
the first class comprises at least one of liquid crystal compounds represented by Chemical Formulas (III), (IV), and (V): 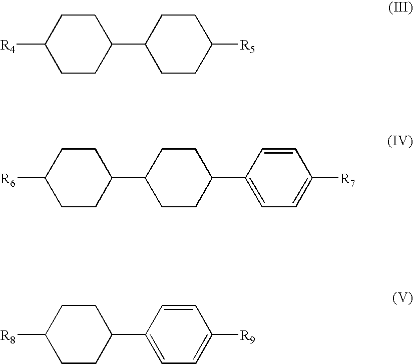
wherein each of R₄ to R₉ is independently of one another an alkyl group, an alkoxy group or an alkenyl group having 1 to 10 C atoms.

4. The liquid crystal composition of claim 3, wherein:
the second class comprises a first sub-class including a liquid crystal compound having a —CF₂O— group and a second sub-class including a liquid crystal compound not having a —CF₂O— group,
the first sub-class comprises a liquid crystal compound represented by said Chemical Formula (II) and a liquid crystal compound represented by Chemical Formula (VI): 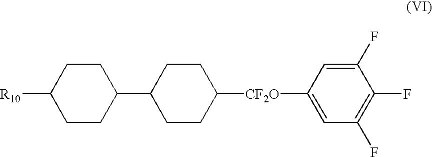
wherein R₁₀ is one of an alkyl group, an alkoxy group, and an alkenyl group having 1 to 10 C atoms, and
the second sub-class comprises at least one of liquid crystal compounds represented by Chemical Formulas (VII), (VIII), (IX), and (X), respectively: 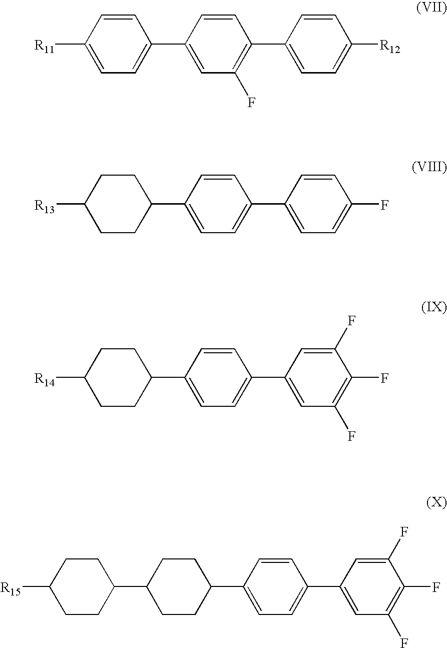
wherein each of R₁₁ to R₁₅ is independently of one another an alkyl group, an alkoxy group or an alkenyl group having 1 to 10 C atoms.

5. The liquid crystal composition of claim 4, wherein:
the first class is about 40 to about 55 wt % of the total content of the liquid crystal composition,
the first sub-class is about 30 to about 40 wt % of the total content of the liquid crystal composition, and
the second sub-class is about 10 to about 30 wt % of the total content of the liquid crystal composition.

6. The liquid crystal composition of claim 5, wherein the liquid crystal composition has an operational temperature range of about −40 to about 80° C.

7. The liquid crystal composition of claim 6, wherein the liquid crystal composition has dielectric anisotropy (Δ∈) of about 8 to 15, and refractive anisotropy (Δn) of about 0.090 to 0.115.

8. A liquid crystal display, comprising:
a first substrate;
a second substrate facing the first substrate;
a pair of field generating electrodes formed on at least one of the first substrate and the second substrate; and
a liquid crystal layer interposed between the first substrate and the second substrate, wherein the liquid crystal layer comprises a liquid crystal composition that includes:
a first class comprising a neutral liquid crystal compound, and
a second class comprising a polar liquid crystal compound having at least one fluorine atom, wherein the second class comprises a liquid crystal compound represented by the Chemical Formula (I):
R₁—CF₂O—R₂ (I)
wherein each of R₁ and R₂ independently contains an aromatic ring having at least one fluorine atom, and further wherein the liquid crystal compound represented by Chemical Formula (I) is less than about 22 wt % of total content of the liquid crystal composition.

9. The liquid crystal display of claim 8, wherein
the liquid crystal compound represented by Chemical Formula (I) is represented by Chemical Formula (II): 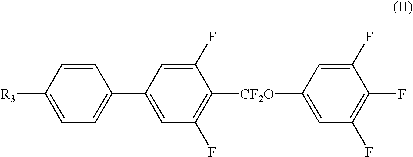
wherein R₃ is one of an alkyl group, an alkoxy group, and an alkenyl group having C₁ to C₁₀.

10. The liquid crystal display of claim 9, wherein
the first class comprises at least one of liquid crystal compounds represented by Chemical Formulas (III), (IV), and (V): 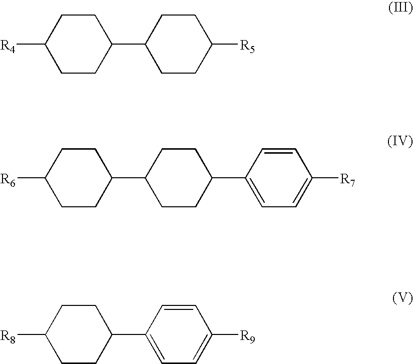
wherein each of R₄ to R₉ is independently of one another an alkyl group, an alkoxy group or an alkenyl group having 1 to 10 C atoms

11. The liquid crystal display of claim 10, wherein:
the second class comprises a first sub-class including a liquid crystal compound having a —CF₂O— group and a second sub-class including a liquid crystal compound not having a —CF₂O— group,
the first sub-class comprises a liquid crystal compound represented by said Chemical Formula (II) and a liquid crystal compound represented by Chemical 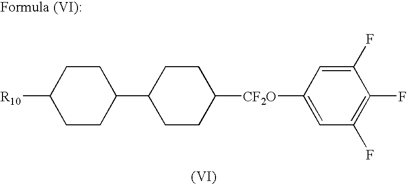
wherein R₁₀ is one selected from an alkyl group, an alkoxy group, and an alkenyl group having 1 to 10 C atoms, and
the second sub-class comprises at least one of liquid crystal compounds represented by Chemical Formulas (VII), (VIII), (IX), and (X): 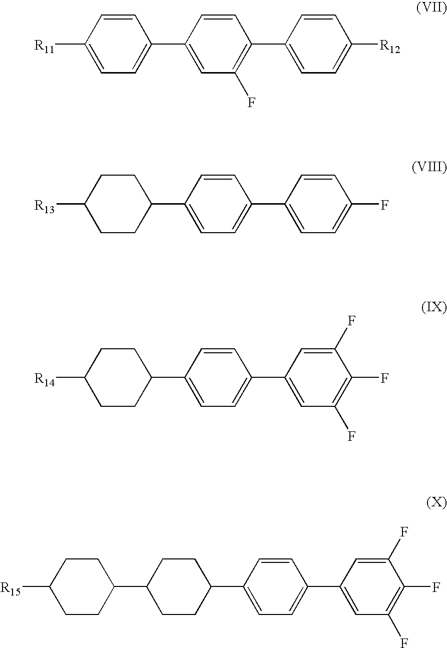
where each of R₁₁ to R₁₅ is independently of one another an alkyl group, an alkoxy group or an alkenyl group having 1 to 10 C atoms.

12. The liquid crystal display of claim 11, wherein:
the first class is about 40 to about 55 wt % of the total content of the liquid crystal composition,
the first sub-class is about 30 to about 40 wt % of the total content of the liquid crystal composition, and
the second sub-class is about 10 to about 30 wt % of the total content of the liquid crystal composition.

13. The liquid crystal display of claim 12, wherein the liquid crystal composition has an operational temperature range of about −40 to about 80° C.

14. The liquid crystal display of claim 13, wherein the liquid crystal composition has dielectric anisotropy (Δ∈) of about 8 to 15, and refractive anisotropy (Δn) of about 0.09 to 0.115.

15. The liquid crystal display of claim 12, further comprising:
a first signal line and a second signal line formed on at least one of the first substrate and the second substrate to cross each other, and
a thin film transistor connected to the first signal line, the second signal line, and the field generating electrodes.
